(19) United States
(12) Patent Application Publication
(10) Pub. No.: US 2015/0286349 A1
(43) Pub. Date: Oct. 8, 2015

(54) TRANSIENT USER INTERFACE ELEMENTS

(71) Applicant: Microsoft Corporation, Redmond, WA (US)

(72) Inventor: Jonathan S. Kaufthal, Seattle, WA (US)

(73) Assignee: Microsoft Corporation, Redmond, WA (US)

(21) Appl. No.: 14/453,515

(22) Filed: Aug. 6, 2014

Related U.S. Application Data
(60) Provisional application No. 61/974,392, filed on Apr. 2, 2014.

(51) Int. Cl. G06F 3/0482; G06F 3/0484

(52) U.S. Cl. CPC G06F 3/0482; G06F 3/04842

(57) ABSTRACT

Surfacing of transient user interface (UI) elements is provided. Various UI elements may only be applicable in certain situations or periods of time. To help preserve screen space, particularly on smaller form devices such as tablet computing devices and mobile communication devices where screen space is restricted, a UI element may appear in the UI when the element is relevant. When the element is no longer relevant, it may disappear from view. The appearance and disappearance of the UI element may be an animation. The animation may provide a smooth transition and thus be non-disruptive or distracting to a user.

### CROSS-REFERENCE TO RELATED APPLICATIONS

The application claims priority to U.S. Provisional Patent Application No. 61/974,392 titled “Transient User Interface Elements” filed Apr. 2, 2014, the disclosure of which is hereby incorporated by reference in its entirety.

### BACKGROUND

Oftentimes there is a need for adequate space in an application user interface for display of commands, information, or other elements. With the increasing popularity of using smaller form devices such as tablet computing devices and mobile communication devices for various computing tasks, screen space for display of user interface elements is even more limited. Additionally, many user interface elements or commands may be relevant in relatively narrow situations or periods of time. Oftentimes when an element or command is not relevant of applicable, the element or command may be disabled yet may still be displayed in the user interface. Transient elements provide a way to balance these competing factors. It is with respect to these and other considerations that the present disclosure has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present disclosure solve the above and other problems by providing surfacing of transient commanding elements. As should be appreciated, it may be considered important to display certain user interface (UI) elements in a standard and prominent location; however, such UI elements may only apply in relatively narrow situations or periods of time. To help preserve screen space, particularly on smaller form devices such as tablet computing devices and mobile communication devices where screen space is more limited, a UI element may animate into place in the UI when the element is relevant. When the element is no longer relevant, it may disappear from view. The animation may provide a smooth transition and thus be non-disruptive or distracting to a user.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the disclosure as claimed.

### BRIEF DESCRIPTION OF THE DRAWINGS

The accompanying drawings, which are incorporated in and constitute a part of this disclosure, illustrate various embodiments of the present disclosure. In the drawings:

FIG. 1 is a block diagram of one embodiment of a system for providing surfacing of transient user interface elements;

FIG. 2A is an illustration of an example user interface displaying a plurality of selectable user interface elements;

FIG. 2B is an illustration of the example user interface wherein an “undo” functionality command is selected;

FIG. 2C is an illustration of a transient selectable user interface element animating into place in the example user interface;

FIG. 2D is an illustration of a user selecting a user interface element from the example user interface and thus making the transient selectable user interface element no longer relevant;

FIG. 2E is an illustration of the transient selectable user interface element animating out of the example user interface;

FIG. 2F is an illustration of the user selecting the transient selectable user interface element;

FIG. 2G is an illustration of the transient selectable user interface element animating out of the example user interface once it is no longer relevant;

FIG. 2H is an illustration of a transient selectable user interface element animating into view below a selected companion functionality command;

FIG. 2I is an illustration of a transient selectable user interface element animating into view in a call-out menu;

FIG. 2J is an illustration of transient selectable user interface elements animating into view in a drop-down menu;

FIG. 2K is an illustration of two applications sharing a display, wherein a transient user interface element is shown in an example user interface for a relevant time period;

FIG. 2L is an illustration of user interface elements animating into view and covering the transient user interface element in the example user interface after the relevant time period;

FIG. 3 is a flow chart of a method for providing surfacing of transient user interface elements;

FIG. 4 is a block diagram illustrating example physical components of a computing device with which embodiments of the disclosure may be practiced;

FIGS. 5A and 5B are simplified block diagrams of a mobile computing device with which embodiments of the present disclosure may be practiced; and

FIG. 6 is a simplified block diagram of a distributed computing system in which embodiments of the present disclosure may be practiced.

### DETAILED DESCRIPTION

The following detailed description refers to the accompanying drawings. Wherever possible, the same reference numbers are used in the drawing and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure, but instead, the proper scope of the disclosure is defined by the appended claims.

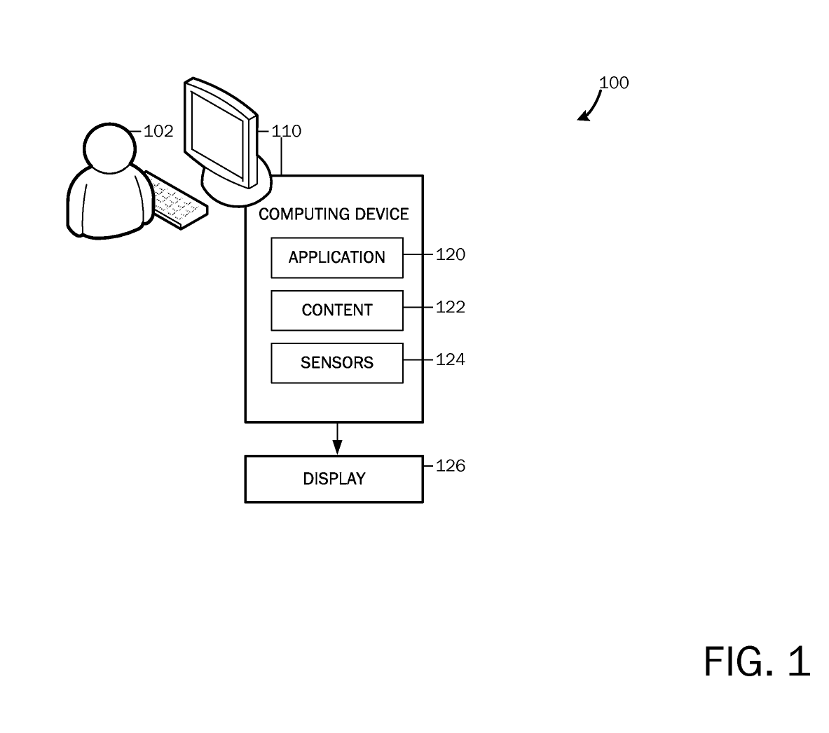

As briefly described above, embodiments of the present disclosure are directed to providing surfacing of transient user interface elements. Referring now to the drawings, in which like numerals represent like elements, various embodiments will be described. FIG. 1 is a block diagram illustrating a system architecture 100 for providing surfacing of transient user interface elements. The network architecture 100 includes a computing device 110. The computing device 110 may be one of various types of computing devices (e.g., a tablet computing device, a desktop computer, a mobile communication device, a laptop computer, a laptop/tablet hybrid computing device, a large screen multi-touch display, a gaming device, a smart television, or other types of computing devices) for executing applications 120 for performing a variety of tasks.

A user 102 may utilize an application 120 on a computing device 110 for a variety of tasks, which may include, for example, to write, calculate, draw, organize, prepare presentations, send and receive electronic mail, take and organize notes, make music, and the like. Applications 120 may include thick client applications, which may be stored locally on the computing device 110 (as illustrated in FIG. 1), or may include thin client applications (i.e., web applications) that may reside on a remote server and accessible over a network, such as the Internet or an intranet. A thin client application may be hosted in a browser-controlled environment or coded in a browser-supported language and reliant on a common web browser to render the application executable on a computing device 110. The computing device 110 may be configured to receive content 122 for presentation on a display 126 (which may comprise a touch screen display).

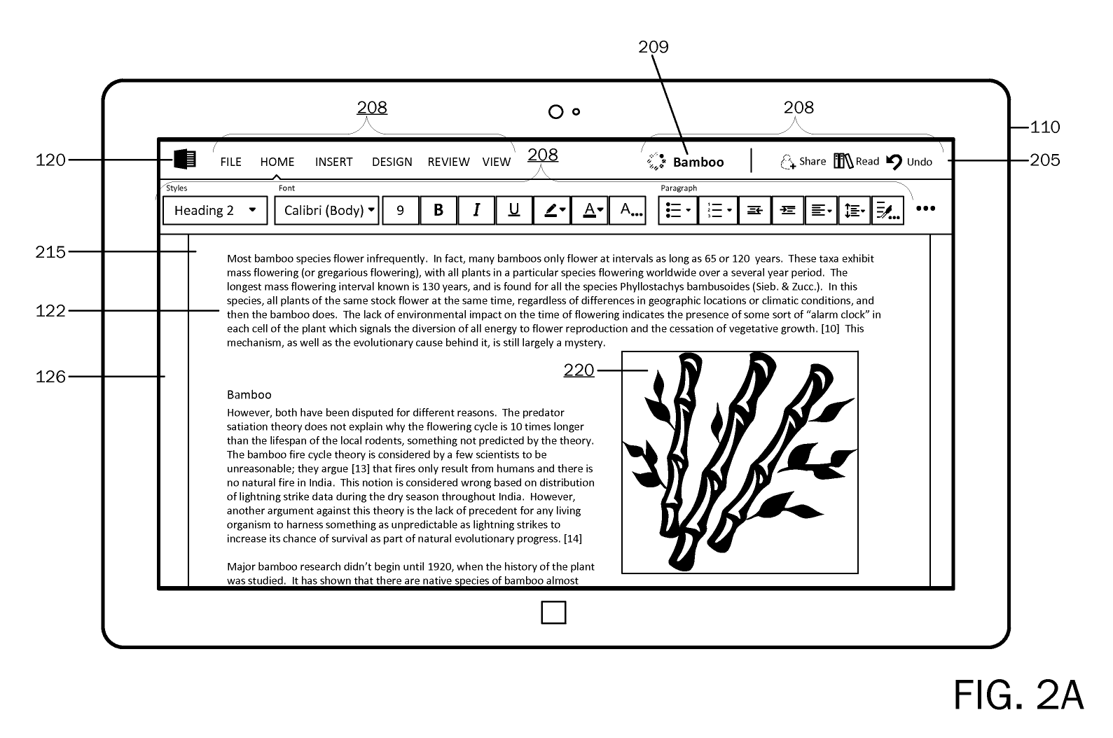

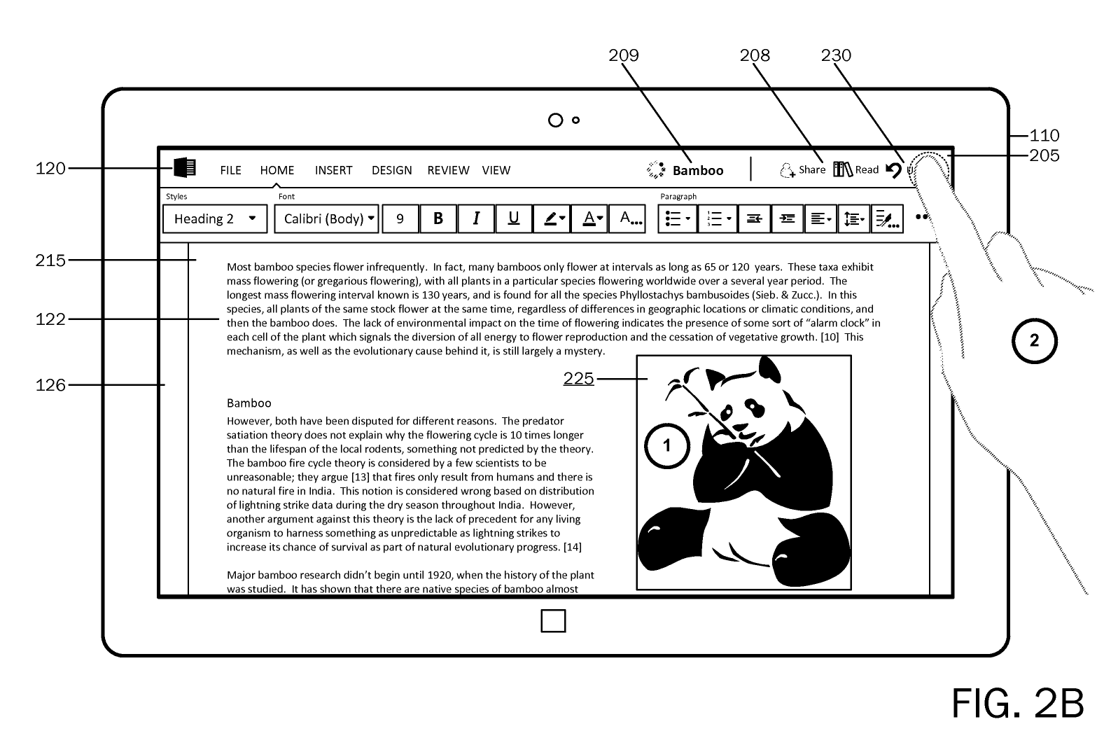

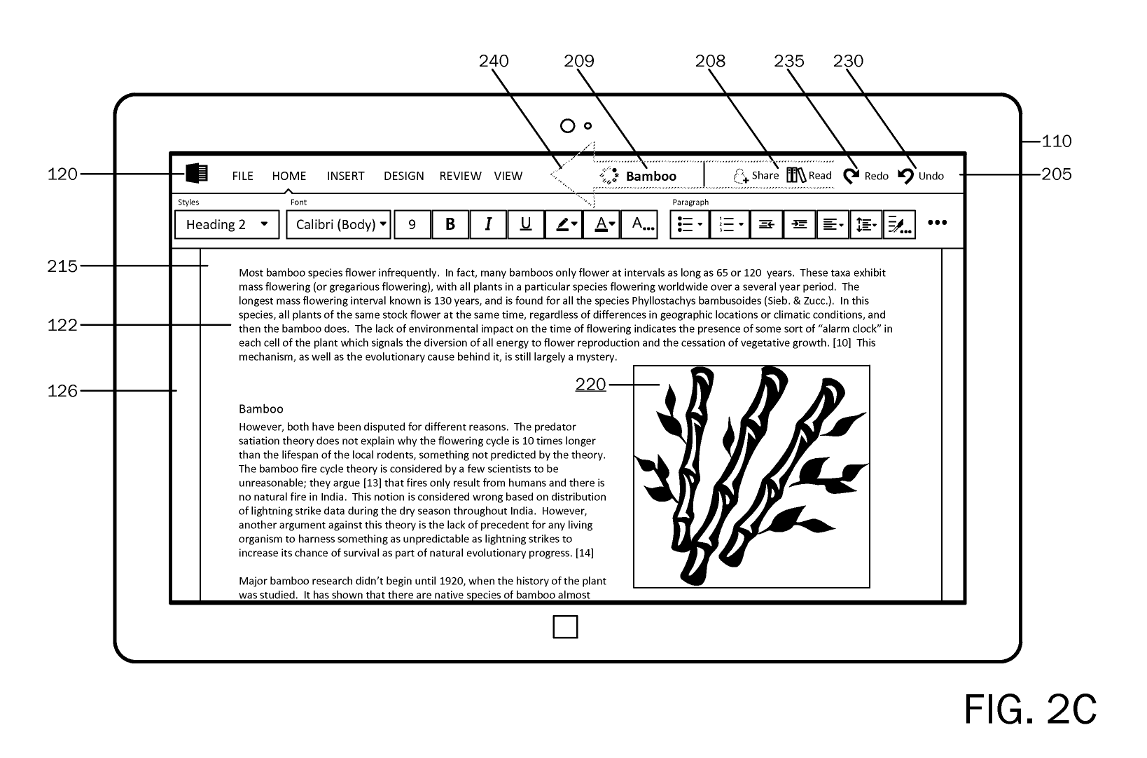

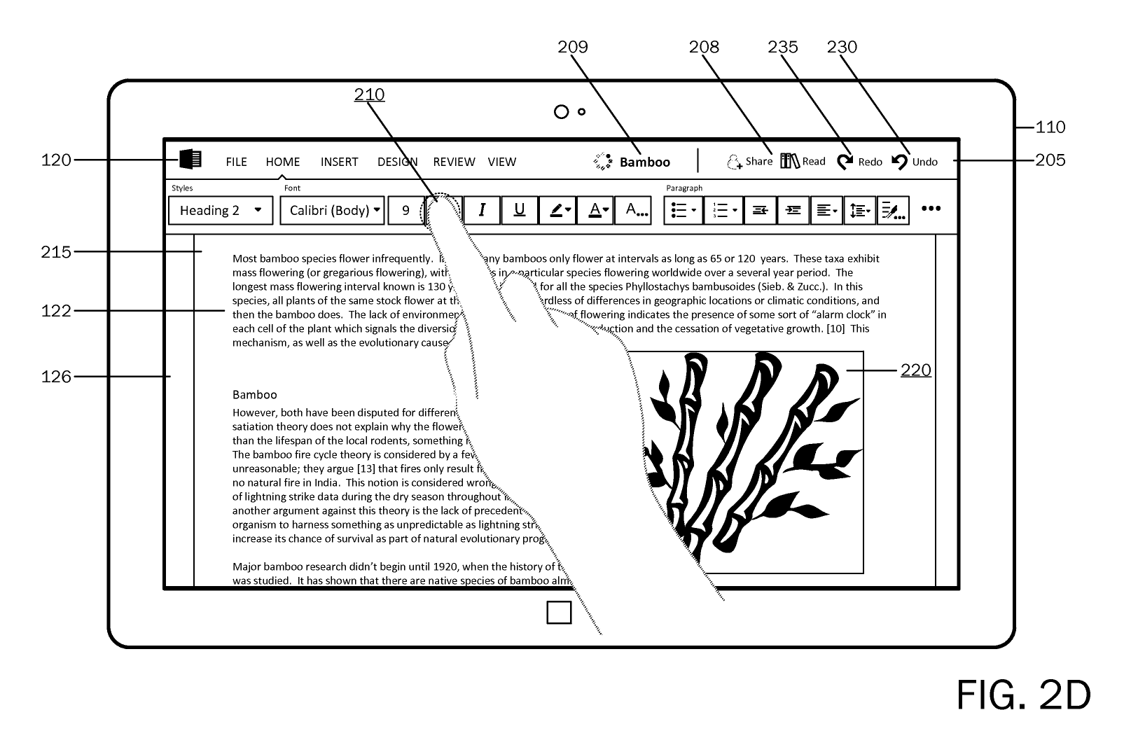

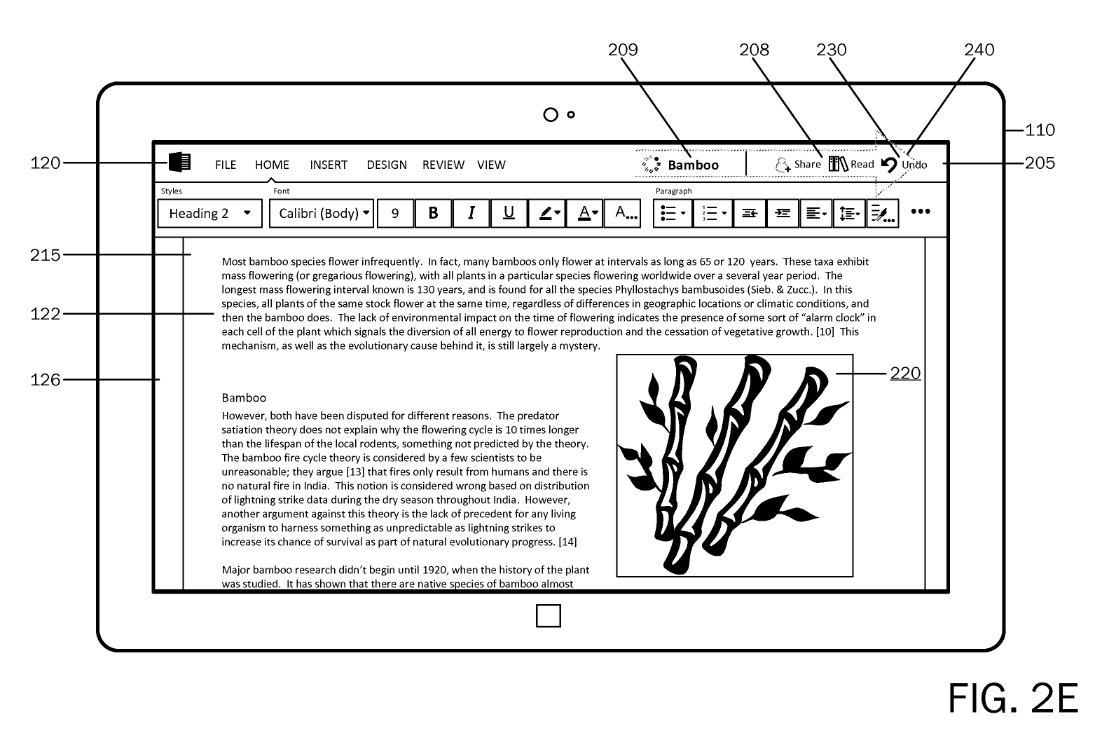

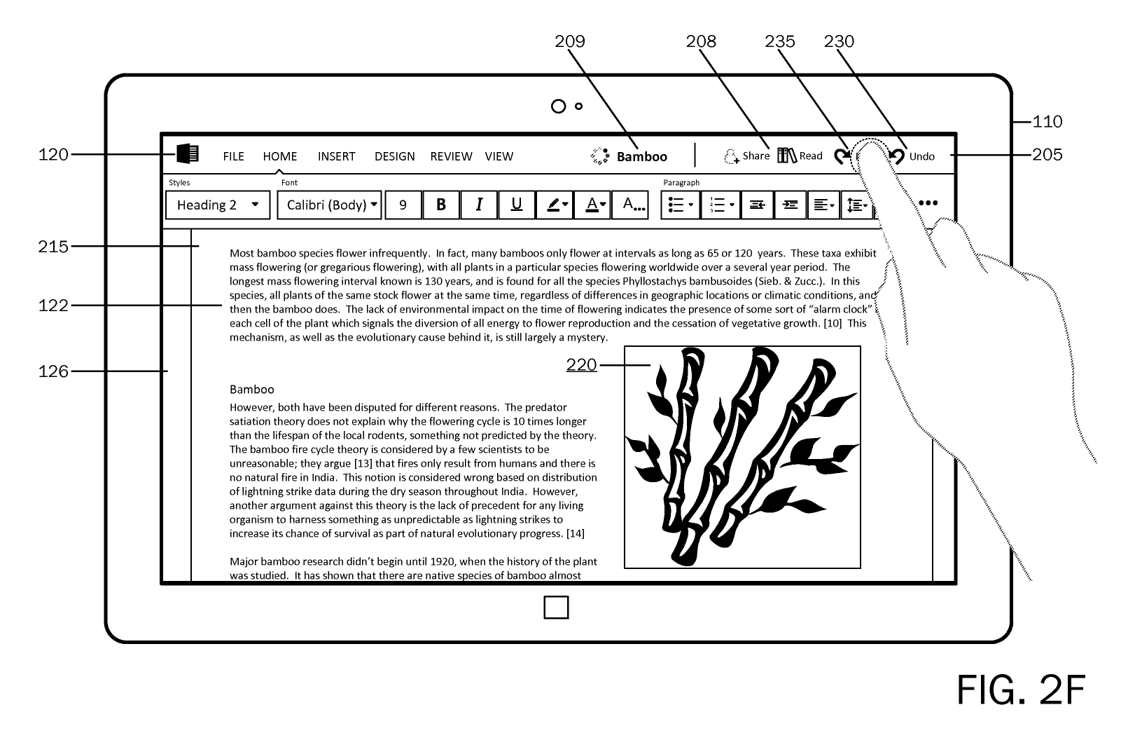

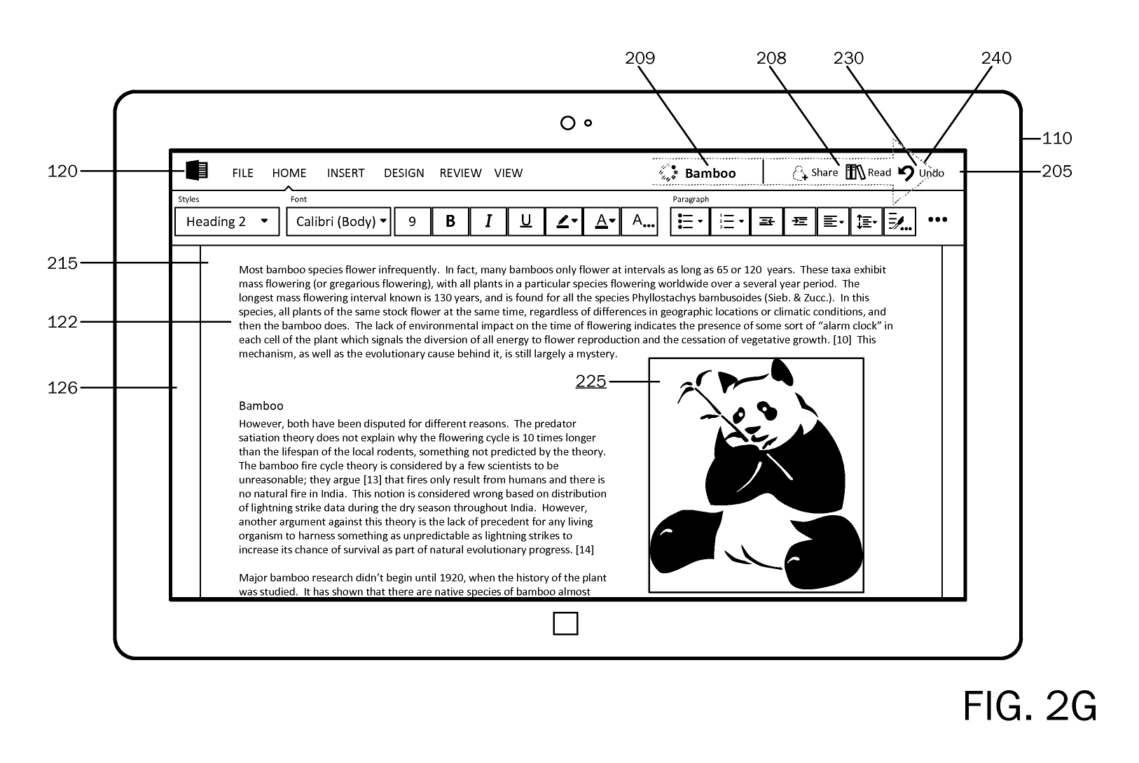

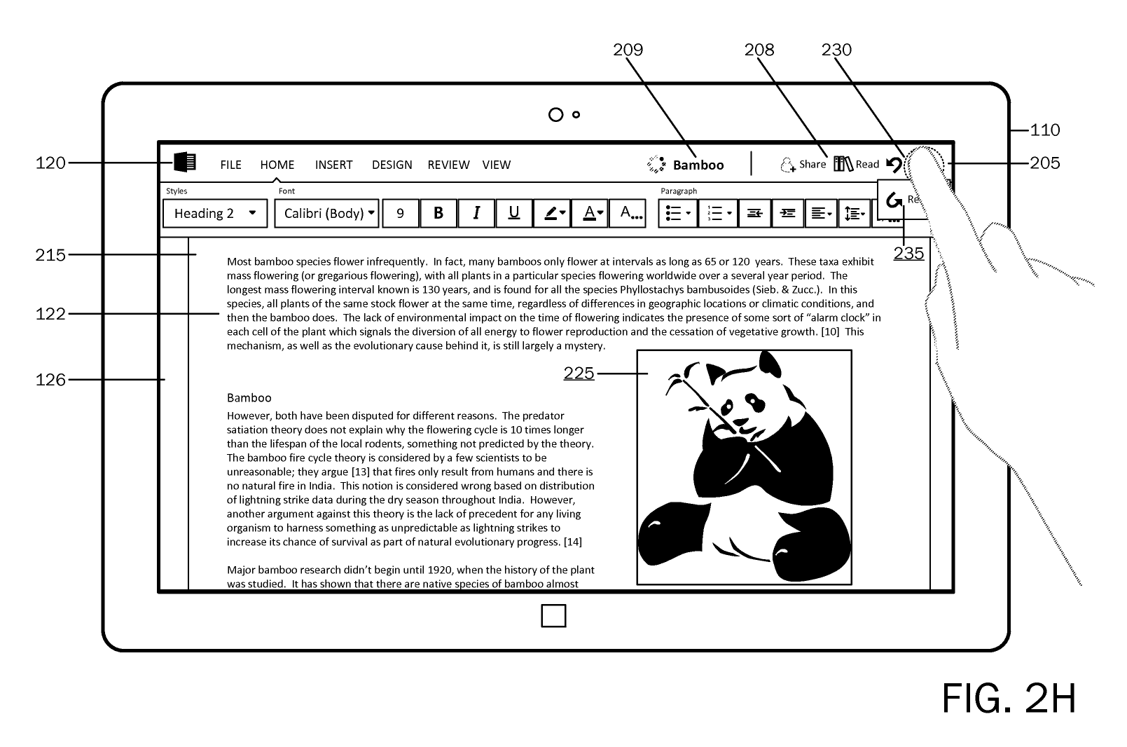

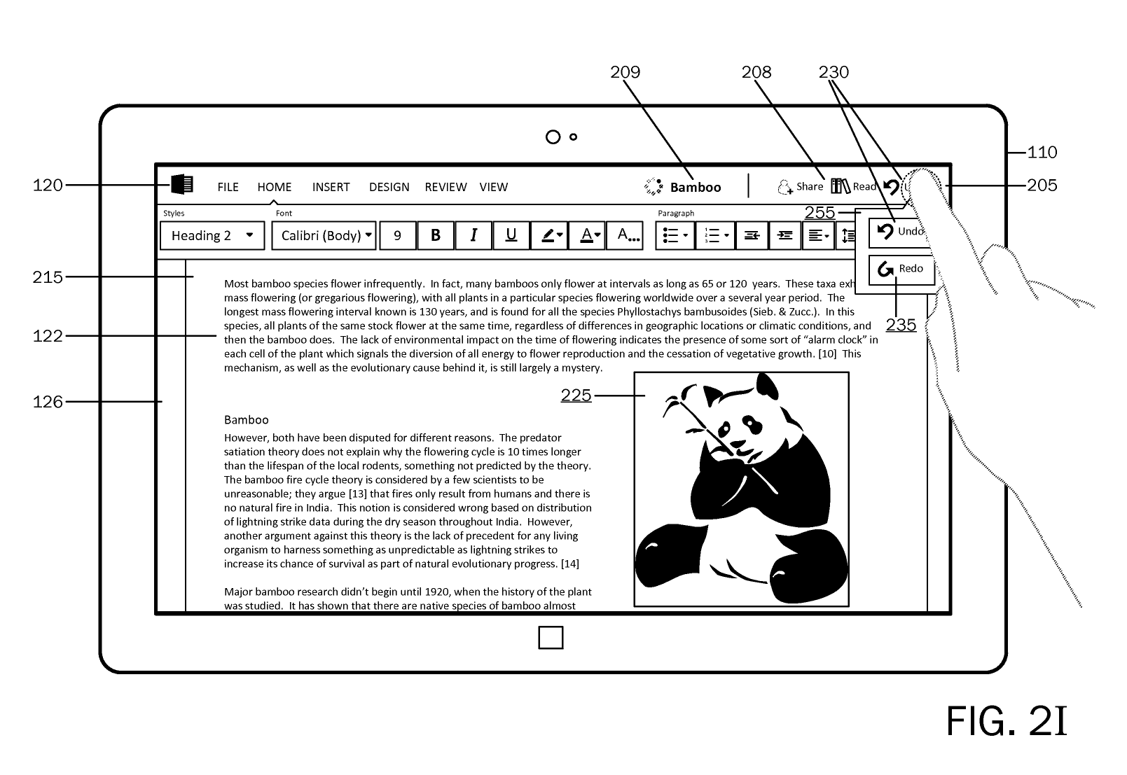

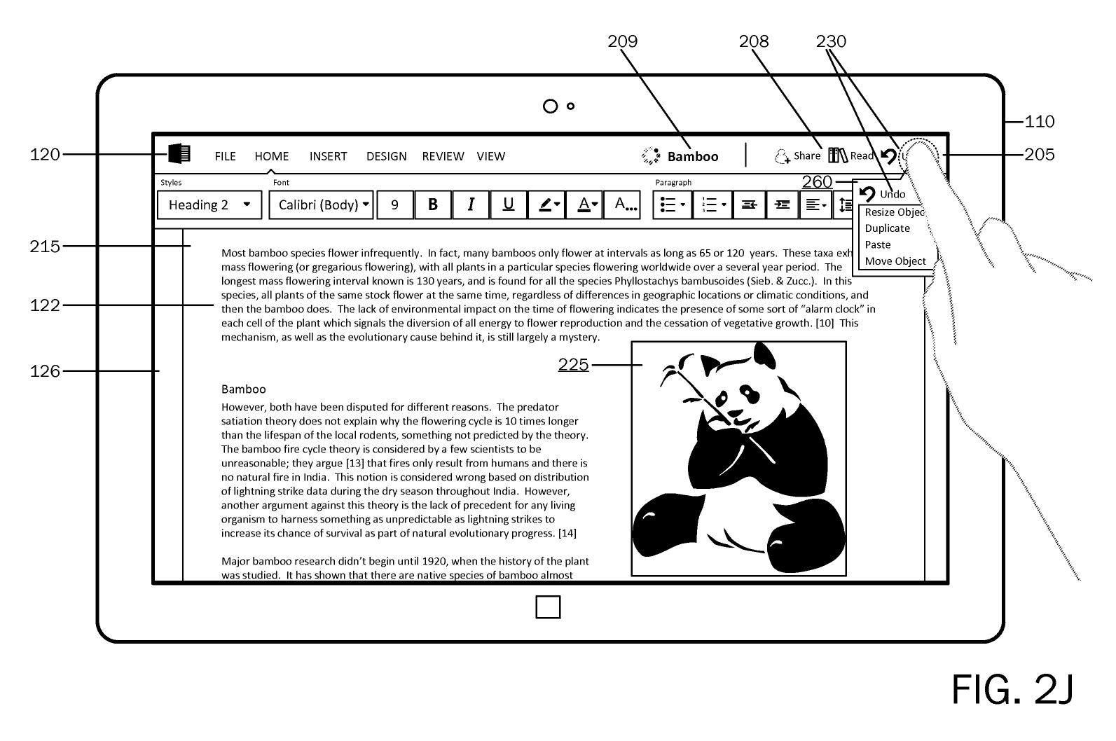

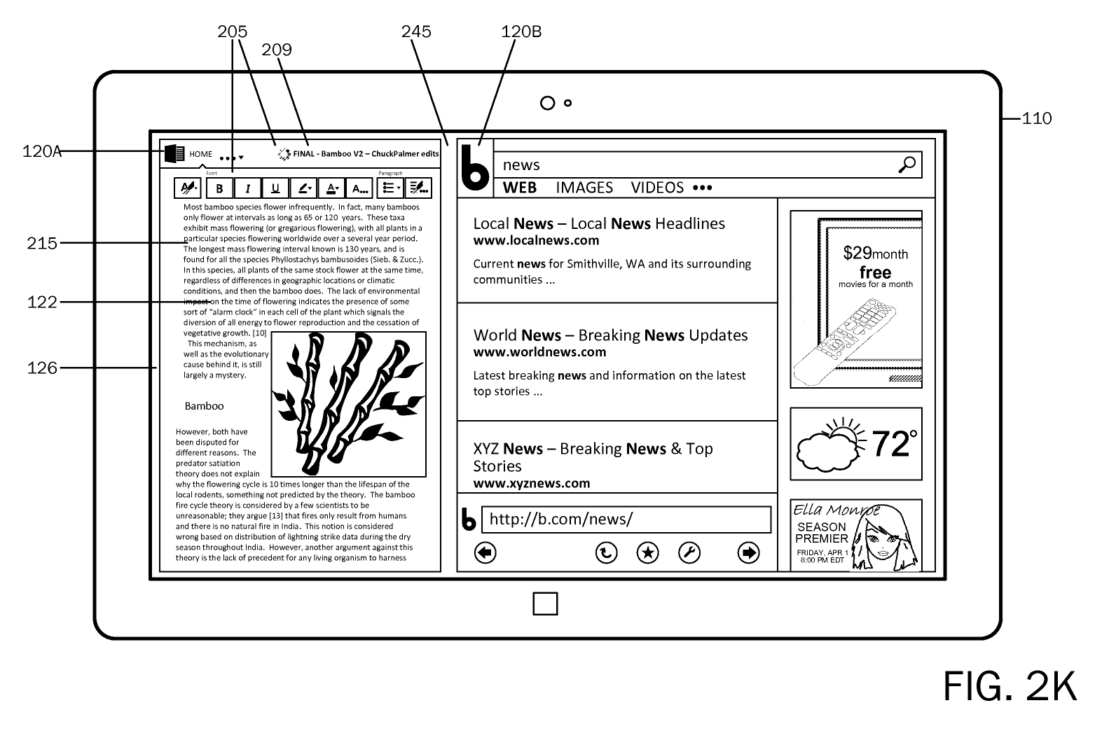

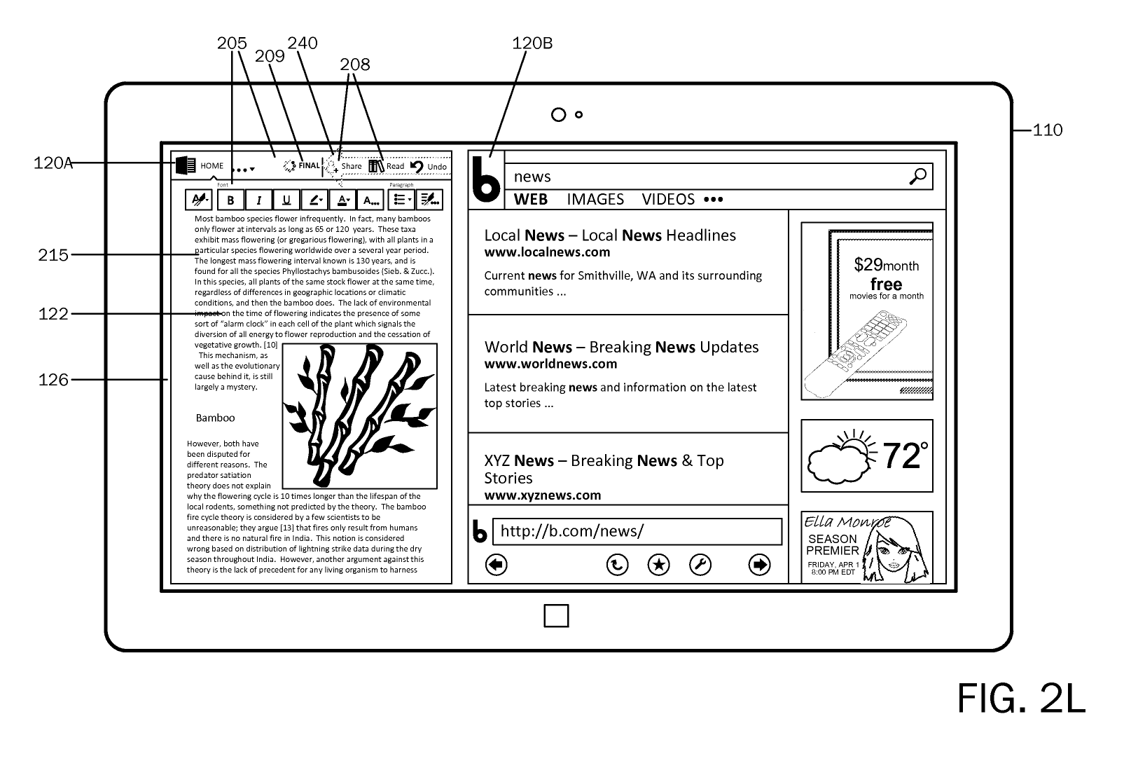

An application 120 may be configured to enable a user 102 to use a pointing device (e.g., a mouse, pen/stylus, etc.) and/or to utilize sensors 124 (e.g., touch sensor, accelerometer, hover, facial recognition, voice recognition, light sensor, proximity sensor, gyroscope, tilt sensor, GPS, etc.) on the computing device 110 to interact with content 122 via a number of input modes. To assist users to locate and utilize functionalities of a given application 120, a user interface (UI) 205 containing a plurality of selectable functionality controls and elements may be provided. According to embodiments and as will be described below in greater detail with reference to FIGS. 2A-2L, transient user interface elements may also be animated into display in the UI 205.

As briefly described above, it may be considered important to display certain commands, bits of information, or user interface (UI) elements (herein collectively referred to as UI elements) in a standard and prominent location; however, such UI elements may only apply in relatively narrow situations or periods of time. To help preserve screen space, particularly on smaller form devices such as tablet computing devices and mobile communication devices where screen space is more limited, certain UI elements may appear in the UI 205 when they are relevant, that is, when the functionality associated with the UI element may be applied. These UI elements are herein referred to as transient UI elements. When the transient UI elements are no longer relevant, they may be removed from view. According to an embodiment, transient UI elements may animate into and/or out of place in the UI 205, for example, may slide in/out, may fade in/out, etc. The animation may be non-disruptive to a user. Space in UI 205 may be reserved for the transient UI elements, providing for non-disruptive scaling changes or distracting switching of contextual UI groupings.

Referring now to FIG. 2A, an example application 120 comprising a user interface 205 is illustrated that may be displayed on any suitable computing device 110 described above. In the illustrated example, the application user interface 205 is shown displayed on a tablet computing device, and comprises a display of a document 215. The document 215 may comprise content 122, such as text, tables, pictures 220, etc. The user interface 205 may include a plurality of functionality elements 208, which may include selectable commands, as well as document and application information (e.g., a document title 209, save state information, etc.). As can be seen in the illustration, space may be limited in the UI 205 for display of information and UI elements 208. Accordingly, select UI elements 208 may be chosen to be displayed as default UI elements. The select UI elements may be chosen according to a variety of factors such as available screen space, most-used UI elements, relevance, etc.

With reference now to FIG. 2B, the example application 120, UI 205, and document 215 of FIG. 2A are shown, and a user 102 has selected to replace a first picture 220 in the document 215 with a second picture 225. The user 102 may then select an “undo” command 230 displayed in the UI 205 which, according to an embodiment, may be a default UI element 208, or according to another embodiment may transition into view once the user 102 provides input that makes the command relevant.

Referring now to FIG. 2C, when the “undo” command 230 is selected, the last action may be undone. In the illustrated example, the second picture 225 may be replaced with the first picture 220. When the action is undone, other UI elements 208, such as a “redo” command, may apply or become relevant. UI elements 208 that appear when they apply and disappear when they no longer apply may herein be referred to as transient UI elements 235. As illustrated, the “redo” command (transient UI element 235) animates into the UI 205, for example, slides into place. The animation 240 may provide for a smooth transition of the transient UI element 235 into display. The animation 240 may provide a subtle visual cue to the user 102 that a new UI element is relevant and available in the UI 205. Space in the UI 205 may be predetermined for any transient UI elements 235 that may be displayed. Accordingly, a re-layout of the UI 205, which may cause disruptive scaling or switching of UI element groupings, may be avoided.

According to an embodiment, empty space in the UI 205 may be reserved for any transient UI elements 235 that may be displayed. Accordingly, the UI 205 may be prevented from having to be re-laid out, as well as preventing a movement of tabs into a switcher. To reserve empty space in the UI 205 for transient UI elements 235, a determination may be made as to which UI elements may show and hide. The UI elements that are determined that may be shown and hidden may be annotated such that fake invisible copies of the UI elements may be created to reserve space and added to the UI layout. Scaling of the UI 205 may be updated to know about the fake UI elements if necessary. When an animation 240 occurs, both the real UI elements and the fake UI elements may animate at the same time. Additionally, other elements that move may be animated at the same time (e.g., title, save or sync indicator, etc.).

The transient UI element 235 may transition into view in various ways. According to an embodiment and as illustrated in FIG. 2C, one or more displayed UI elements 208 may slide into whitespace or empty space in the UI 205 to make room for the transient UI element 235. For example, the document title 209, a “share” command, and a “read” command may be moved to the side via a slide animation 240 to make room for the “redo” command (transient UI element 235). The “redo” command (transient UI element 235) may be displayed beside a companion UI element 208, in this example, the “undo” command 230. As should be appreciated, the slide animation 240 and displacement of UI elements 208 into empty space in the UI 205 for display of the transient UI element 235 is but one of many methods of surfacing a transient UI element 235.

As described above, a transient UI element 235 may be displayed as long as it applies or is relevant. A user 102 may make an input or select a functionality that may make a displayed transient UI element no longer applicable. With reference now to FIG. 2D, the user 102 selecting another functionality command 210, in this example, a “bold” command, is illustrated. Accordingly, the “redo” command may no longer apply and, as illustrated in FIG. 2E, may disappear from the UI 205. Any UI elements 208 that may have been moved or slid for display of the transient UI element 235 may animate back into their starting position.

FIG. 2F shows the user 102 selecting the transient UI element 235, in this example, the “redo” command. Accordingly, as illustrated in FIG. 2G, the action that was previously undone by the “undo” command 230 may be redone. For example, the first picture 220 may again be replaced by the second picture 225. If the transient UI element 235 is no longer applicable (e.g., no other actions can be redone at that time), the transient UI element 235 may disappear from the UI 205, and any UI elements 208 that may have been moved or slid for display of the transient UI element 235 may animate back into their starting position.

As mentioned above, the slide animation 240 and displacement of UI elements 208 to empty space in the UI 205 for display of the transient UI element 235 is but one of many methods of surfacing a transient UI element 235. For example, if there is not available empty space in the UI 205, one or more UI elements 208 may be truncated or temporarily covered to make room for the transient UI element 235. As another example and as illustrated in FIG. 2H, when a transient UI element 235 becomes relevant, it may be displayed on or proximate to a companion UI element 208. In the example illustrated in FIG. 2H, when the user 102 selects the “undo” command 230, the “redo” command is surfaced on or proximate to the “undo” command 230. The transient UI element 235 may remain displayed as long as it is relevant.

As another example and as illustrated in FIG. 2I, when a transient UI element 235 becomes relevant, it may be surfaced in a callout menu 255. The callout menu 255 may comprise one or more UI elements 208 including one or more transient UI elements 235.

Sometimes a functionality may apply to multiple actions, for example, when navigating, undoing actions, redoing actions, etc. As illustrated in FIG. 2J, a dropdown menu 260 comprising the last n actions or navigable sites applicable to a given functionality may be displayed. For example, selection of an “undo” command 230 may surface a dropdown menu 260 comprising the last n actions that may be undone. The user 102 may select an action, and the selected action and any actions that came after the selected action may be undone. The dropdown menu 260 may then disappear from view.

The above examples describe surfacing a transient UI element 235 when the element applies according to a received input made by the user 102 (e.g., surfacing a “redo” command after selection of an “undo” command). According to embodiments, applicability of a transient UI element 235 may be determined according to a function of time. For example, when an application 120 is opened and displayed, one or more transient UI elements 235 may be displayed for a predetermined or calculated time period. After the predetermined or calculated time period passes, the applicability of the transient UI element 235 may be reduced and accordingly may be removed from display.

With reference now to FIG. 2K, two applications 120A,B are shown displayed on the display surface 126. In the illustrated example, a word processing application 120A is displayed on the left of the screen and a web browser application 120B is displayed on the right of the screen. As can be appreciated, when the word processing application 120A is first opened or when a document 215 is created or opened in the application, the title 209 of the document 215 may be considered relevant information. For example, the title 209 may help to provide confirmation to the user 102 of which document 215 he/she is looking at or editing. After a given amount of time, the relevance of displaying the document title 209 may decrease. Accordingly, and as illustrated in FIG. 2L, the title 209 may be minimized, truncated, or temporarily covered, and other UI elements 208 that may be more likely to apply or to be relevant may animate 240 into view.

As should be appreciated, the user interface components, content items and specific application functionalities illustrated and described herein are for purposes of example and illustration only and are not limiting of different software applications and user interface components and layouts that may be used in accordance with embodiments of the present disclosure.

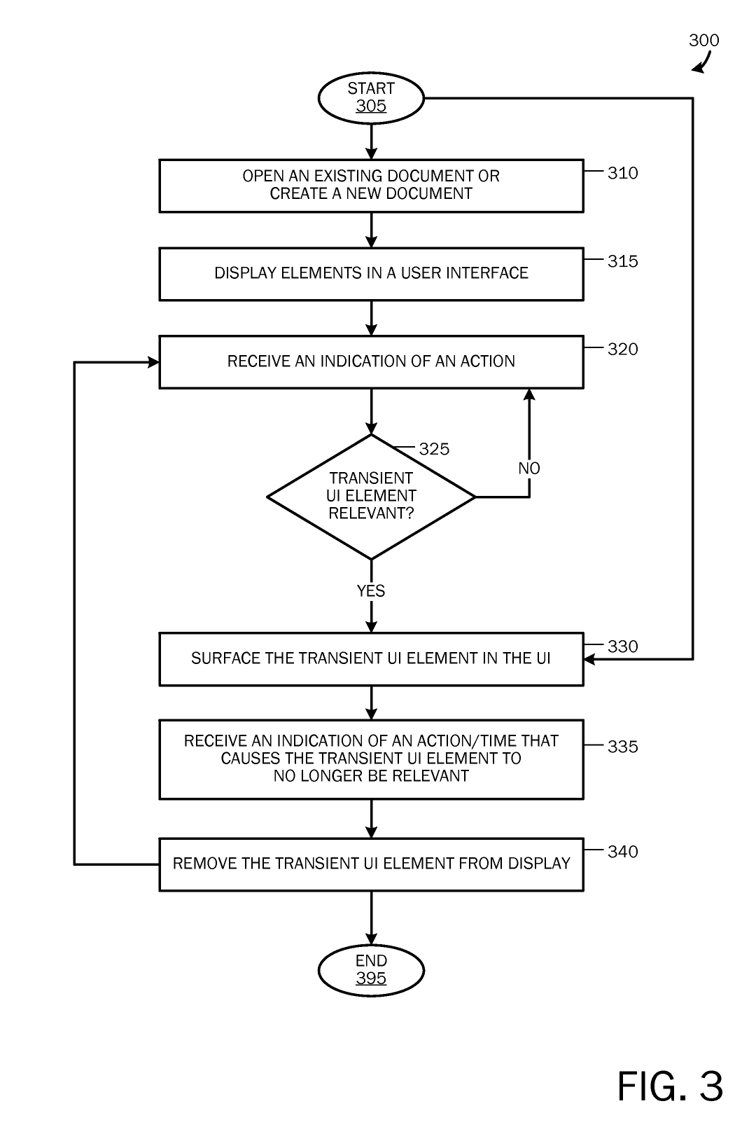

FIG. 3 is a flow chart showing one embodiment of a method 300 for providing surfacing of a transient UI element 235. The method 300 starts at OPERATION 305 and proceeds to OPERATION 310, where an application 120 is opened, an existing document 215 is opened, or a new document 215 is created in the application 120.

The method 300 may proceed to OPERATION 315, where one or more UI elements 208 may be displayed in the user interface 205. As described above, UI elements 208 may include selectable commands, as well as document and application information (e.g., a document title 209, save state information, etc.). The displayed UI elements 208 may be defined by a developer of the application 120 as default elements or as UI elements that should be always displayed.

At OPERATION 320, an indication of an action may be received. For example, a user may select a functionality command, may input content 122, may erase content 122, modify content 122, etc.

The method 300 may proceed to DECISION OPERATION 325, where a determination may be made as to whether a transient UI element 235 is relevant. As described above, relevance may be determined according to actions or according to time.

If a determination is made at DECISION OPERATION 325 that the transient UI element 235 is not relevant, the method 300 may return to OPERATION 320, where an indication of an action may be received. If a determination is made at DECISION OPERATION 325 that the transient UI element 235 is relevant, the method 300 may proceed to OPERATION 330, where the transient UI element 235 may be surfaced in the user interface 205. The transient UI element 235 may animate into view. As described above, the transient UI element 235 may be surfaced in various ways and may cause other displayed UI elements to slide, truncate, collapse, or be temporarily covered.

The method 300 may also start at OPERATION 305 and proceed directly to OPERATION 330, where a transient UI element 235 is first displayed upon start of an application 120 or opening or creation of a document 215. For example, the method 300 may proceed directly to OPERATION 330 such as in the use case described with reference to FIGS. 2K and 2L.

The method 300 may proceed from OPERATION 330 to OPERATION 335, where an indication of an action is received or a predetermined time period has elapsed, and the transient UI element 235 has become irrelevant or no longer applies.

The method 300 may proceed to OPERATION 340, where the transient UI element 235 may disappear from view. According to an embodiment, the transient UI element 235 may animate out, and any UI elements 208 that were moved, truncated, or covered may animate back to their starting state. The method 300 may return to OPERATION 320, where an indication of an action is received, or may end at OPERATION 395.

While the disclosure has been described in the general context of program modules that execute in conjunction with an application program that runs on an operating system on a computer, those skilled in the art will recognize that the disclosure may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

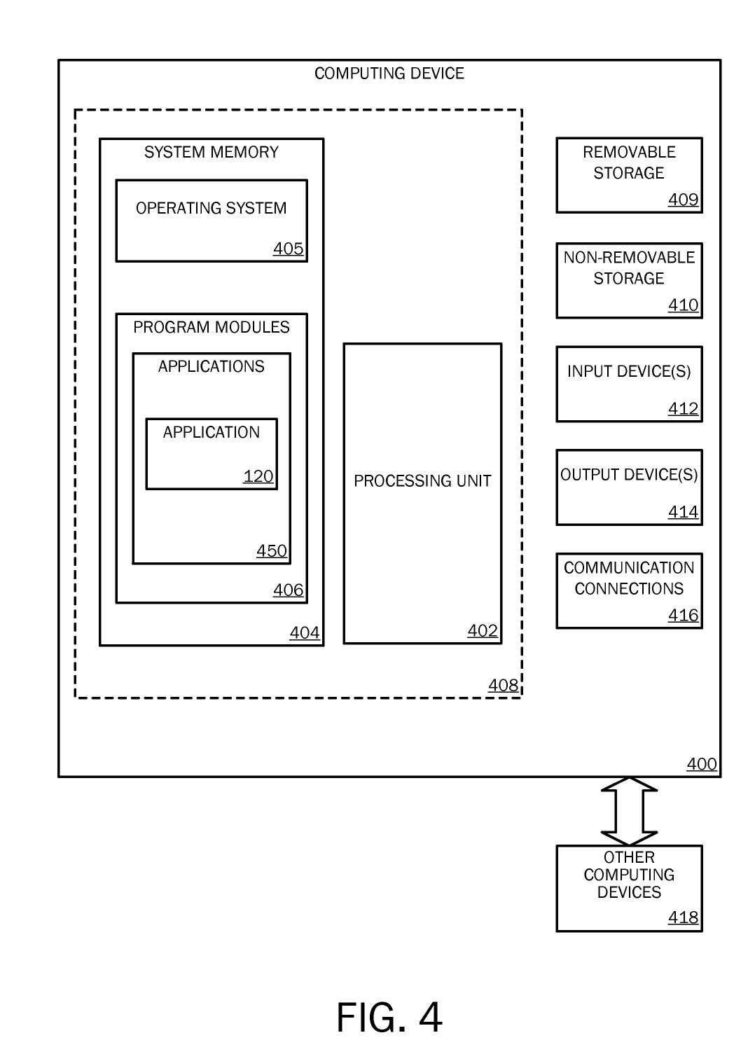

FIGS. 4-6 and the associated descriptions provide a discussion of a variety of operating environments in which embodiments of the disclosure may be practiced. However, the devices and systems illustrated and discussed with respect to FIGS. 4-6 are for purposes of example and illustration and are not limiting of a vast number of computing device configurations that may be utilized for practicing embodiments of the disclosure, described herein.

FIG. 4 is a block diagram illustrating physical components (i.e., hardware) of a computing device 400 with which embodiments of the disclosure may be practiced. The computing device components described below may be suitable for the computing device 110 described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450 such as client application 120. The operating system 405, for example, may be suitable for controlling the operation of the computing device 400. Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present disclosure and may include applications such as electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing surfacing of a transient UI element 235 may be operated via application-specific logic integrated with other components of the computing device 400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated data signal.

Communication media may be embodied by computer readable instructions, data structures, program modules, or other data in a data signal, such as a carrier wave or other transport mechanism, and includes any information delivery media. The term “data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

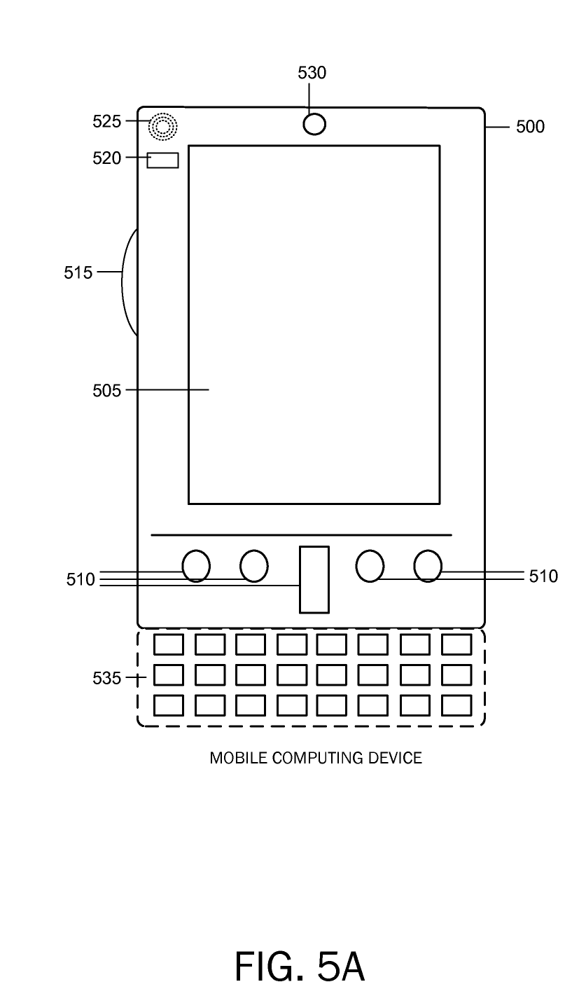

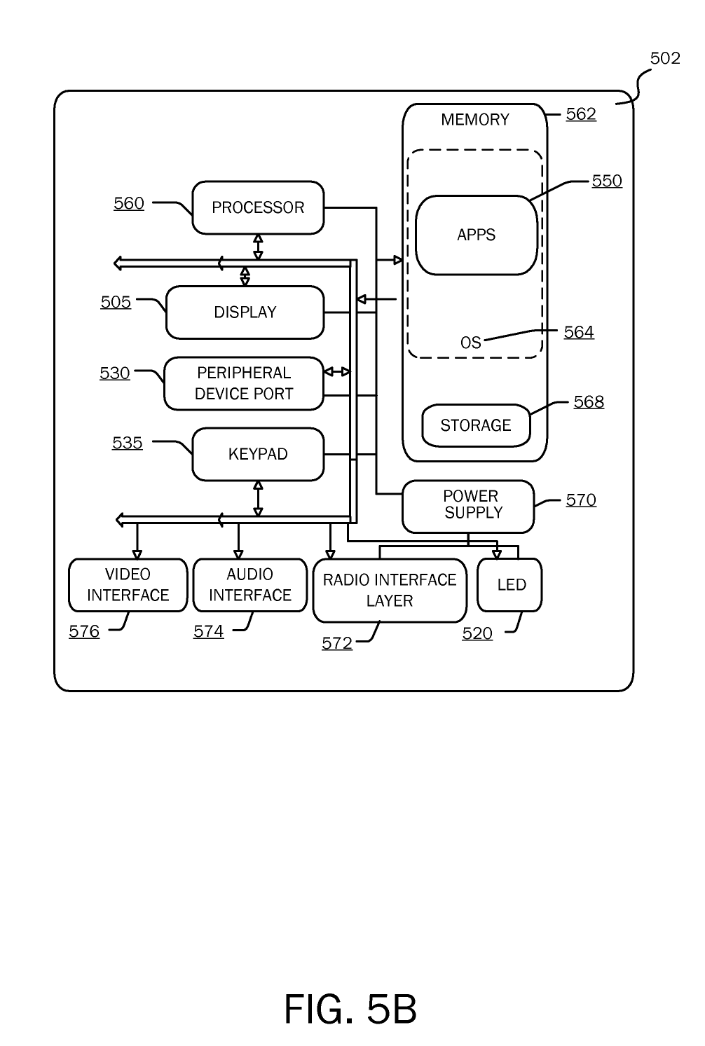

FIGS. 5A and 5B illustrate a mobile computing device 500, for example, a mobile telephone, a smart phone, a tablet personal computer, a laptop computer, and the like, with which embodiments of the disclosure may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 550 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 150 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

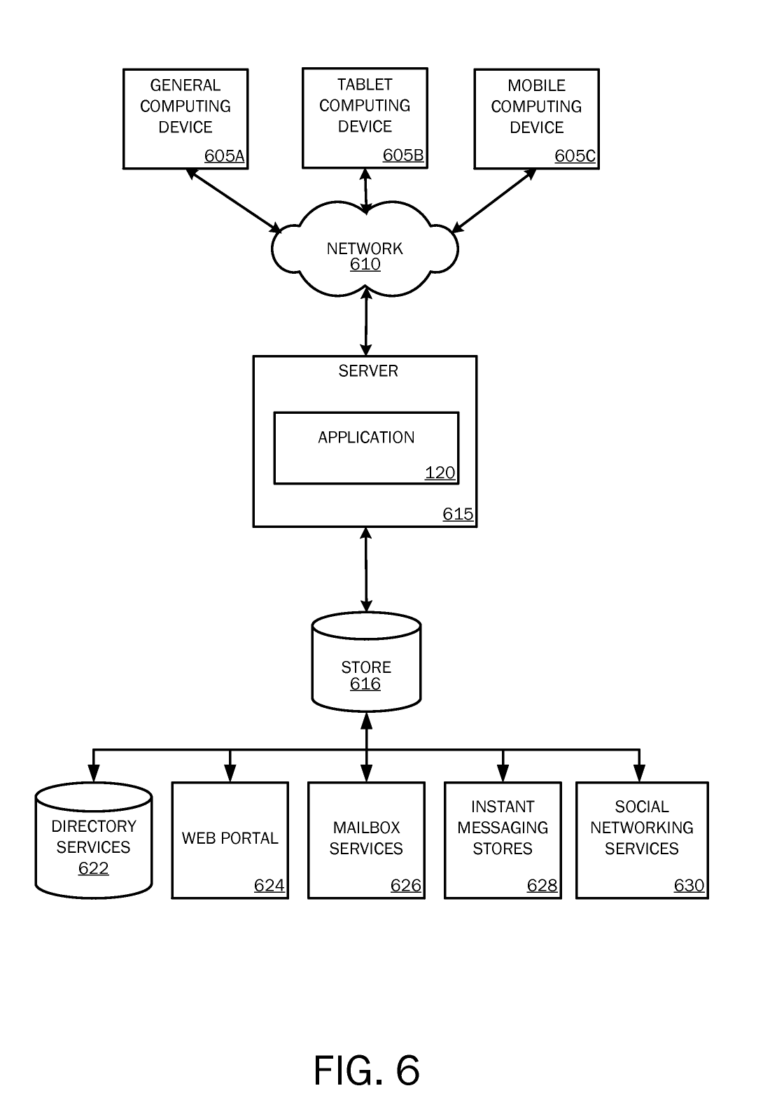

FIG. 6 illustrates one embodiment of the architecture of a system for providing surfacing of a transient UI element 235, as described above. Content developed, interacted with, or edited in association with the application 120 may be stored in different communication channels or other storage types. For example, various documents may be stored using a directory service 622, a web portal 624, a mailbox service 626, an instant messaging store 628, or a social networking site 630. The application 120 may use any of these types of systems or the like for surfacing a transient UI element 235, as described herein. A server 615 may provide the application 120 to clients. As one example, the server 615 may be a web server providing the application 120 over the web. The server 615 may provide the application 120 over the web to clients through a network 610. By way of example, the client computing device 110 may be implemented and embodied in a personal computer 605A, a tablet computing device 605B and/or a mobile computing device 605C (e.g., a smart phone), or other computing device. Any of these embodiments of the client computing device may obtain content from the store 616.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the disclosure as claimed in any way. The embodiments, examples, and details provided in this application are considered sufficient to convey possession and enable others to make and use the best mode of claimed disclosure. The claimed disclosure should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed disclosure.

We claim:

1. A method for providing surfacing of a transient user interface element, the method comprising:
displaying one or more user interface elements in a user interface;
determining a relevance of a transient user interface element;
surfacing the transient user interface element in the user interface;
determining that the transient user interface element is not relevant; and
removing the transient user interface element from display.

2. The method of claim 1, wherein prior to determining a relevance of a transient user interface element, receiving an indication of a user action, the user action comprising one of:
selection of a functionality command;
input of content;
modification of content; or
deletion of content.

3. The method of claim 1, wherein determining a relevance of a transient user interface element comprises determining a functionality associated with the transient user interface element can be applied.

4. The method of claim 1, wherein surfacing the transient user interface element in the user interface comprises animating the transient user interface element into display.

5. The method of claim 1, wherein surfacing the transient user interface element in the user interface causes other displayed user interface elements to slide, truncate, collapse, or be temporarily covered.

6. The method of claim 1, wherein determining that the transient user interface element is not relevant comprises:
determining a functionality associated with the transient user interface element cannot be applied; or
determining a calculated or predetermined amount of time has passed since surfacing the transient user interface element in the user interface.

7. The method of claim 1, wherein determining a relevance of a transient user interface element comprises:
determining the relevance of the transient user interface element is greater than a relevance of a user interface element displayed in a user interface;
surfacing the transient user interface element and temporarily covering the user interface element displayed in the user interface;
after a calculated or predetermined amount of time has passed or upon determining the relevance of the transient user interface element is no longer greater than the relevance of the user interface element, removing the transient user interface element from display in the user interface.

8. The method of claim 7, wherein removing the transient user interface element from display in the user interface comprises animating the transient user interface element out of display.

9. A system for providing surfacing of a transient user interface element, the system comprising one or more processors; and
a memory coupled to the one or more processors, the one or more processors operable to:
display one or more user interface elements in an application user interface;
determine a relevance of a transient user interface element;
surface the transient user interface element in the application user interface;
determine that the transient user interface element is not relevant; and
remove the transient user interface element from display.

10. The system of claim 9, wherein prior to determining a relevance of a transient user interface element, the one or more processors are further operable to receive an indication of an action, the action comprising one of:
selection of a functionality command;
input of content;
modification of content; or
deletion of content.

11. The system of claim 9, wherein in determining a relevance of a transient user interface element, the one or more processors are operable to determine a functionality associated with the transient user interface element can be applied.

12. The system of claim 9, wherein in surfacing the transient user interface element in the application user interface, the one or more processors are operable to animate the transient user interface element into display.

13. The system of claim 9, wherein in surfacing the transient user interface element in the application user interface, the one or more processors are operable to slide, truncate, collapse, or temporarily cover other displayed user interface elements.

14. The system of claim 9, wherein in determining that the transient user interface element is not relevant, the one or more processors are operable to:
determine a functionality associated with the transient user interface element cannot be applied; or
determine a calculated or predetermined amount of time has passed since surfacing the transient user interface element in the application user interface.

15. The system of claim 9, wherein in determining a relevance of a transient user interface element, the one or more processors are operable to:
determine the relevance of the transient user interface element is greater than a relevance of a user interface element displayed in a application user interface;
surface the transient user interface element and temporarily covering the user interface element displayed in the application user interface; and
after a calculated or predetermined amount of time has passed or upon determining the relevance of the transient user interface element is no longer greater than the relevance of the user interface element, remove the transient user interface element from display in the application user interface.

16. A computer readable medium containing computer executable instructions which when executed by a computer perform a method for providing surfacing of a transient user interface element, the method comprising:
displaying one or more user interface elements in an application user interface;
determining a relevance of a transient user interface element, wherein determining a relevance of a transient user interface element comprises determining a functionality associated with the transient user interface element can be applied;
surfacing the transient user interface element in the application user interface;
determining that the transient user interface element is not relevant; and
removing the transient user interface element from display.

17. The computer readable medium of claim 16, wherein prior to determining a relevance of a transient user interface element, receiving an indication of a user action, the user action comprising one of:
selection of a functionality command;
input of content;
modification of content; or
deletion of content.

18. The computer readable medium of claim 16, wherein upon surfacing the transient user interface element in the user interface, sliding, truncating, collapsing, or temporarily covering other displayed user interface elements in the application user interface.

19. The computer readable medium of claim 16, wherein determining that the transient user interface element is not relevant comprises:
determining a functionality associated with the transient user interface element cannot be applied; or
determining a calculated or predetermined amount of time has passed since surfacing the transient user interface element in the user interface.

20. The computer readable medium of claim 16, wherein determining a relevance of a transient user interface element comprises:
determining the relevance of the transient user interface element is greater than a relevance of a user interface element displayed in a user interface;
surfacing the transient user interface element and temporarily covering the user interface element displayed in the user interface; and
after a calculated or predetermined amount of time has passed or upon determining the relevance of the transient user interface element is no longer greater than the relevance of the user interface element, removing the transient user interface element from display in the user interface.
